(19) United States
(12) Patent Application Publication
(10) Pub. No.: US 2003/0132254 A1
(43) Pub. Date: Jul. 17, 2003

(54) Automatic actuator for aerosol valves

(76) Inventor: Guillermo Luis Giangreco, Buenos Aires (AR)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/305,843

(22) Filed: Nov. 27, 2002

(30) Foreign Application Priority Data
Nov. 29, 2001 (AR) M 01 01 05570

(51) Int. Cl. B67D 3/00

(52) U.S. Cl. 222/504

(57) ABSTRACT

Automatic device for actuating aerosol valves of conventional aerosol containers, for controllably spraying doses of a liquid contained in the containers, the device comprising a main support for mounting onto the aerosol container and a valve for connecting to the aerosol valve, the valve being operated by a motor capable of automatically opening and closing the valve according to a desired spraying pattern for providing doses of sprayed liquid through a nozzle in the main support.

### BACKGROUND OF THE INVENTION

1. Field of the Invention

The present invention relates to the field of aerosol or spraying containers and more precisely refers to an automatic device for automatically actuating the aerosol valves of conventional aerosol containers according to a desired and/or programmed spraying pattern.

2. Description of the Prior Art

It is very well known to provide many liquids in containers under pressure and containers with a valve to supply the liquid in a spray, mist or aerosol pattern. These containers, generally known as aerosol containers, are employed in a number of fields. For example, personal deodorants or room aromatic aerosols, insecticides and other products are sprayed by depressing an operating button located at an upper end of the aerosol container. The operating button is placed over a valve tube that opens an aerosol valve upon depression. When depressed, the liquid is ejected through a spraying nozzle in a cap of the aerosol container and the spraying is maintained during depression of the button.

There are many types of operating buttons, some of them in the form of large caps covering all the upper end of the aerosol container or simply a little button, some times with a convenient shape for placing a finger of an user. In all the cases, however, the aerosol container must be taken by the user's hand and operated by depressing the button when desired. While it is a need to have an aerosol container capable of spraying automatically a liquid according to a desired pattern in a desired room or place, depending for example of the light conditions, time conditions, etc., there is no known devices permitting a controlled and automatic operation of an aerosol container.

It would be therefore convenient to have a device capable of connecting to a conventional aerosol container for programming a controlled spraying pattern according to desired parameters, such as light, time etc.

### 3. SUMMARY OF THE INVENTION

It is therefore an object of the present invention to provide an automatic device for actuating aerosol valves of conventional aerosol containers, for controllably spraying doses of a liquid contained in the containers, the device comprising a main support for mounting onto the aerosol container and a valve for connecting to the aerosol valve, the valve being operated by a motor capable of automatically opening and closing the valve according to a desired spraying pattern for providing doses of sprayed liquid through a nozzle in the main support.

It is still another object of the present invention to provide an automatic actuator for aerosol valves of conventional aerosol containers for spraying a liquid contained in the containers, wherein the aerosol valve comprises a valve tube projecting beyond the container and the valve tube is operated to open the aerosol valve by depressing the tube against the action of a spring, the automatic actuator comprising:

i. a main support for mounting onto the aerosol container;

ii. normally closed valve means in the support for connecting to the valve tube in a manner that the tube remains depressed while connected to the valve means;

iii. valve actuating means for opening and closing the valve means, the valve actuating means comprising a rotary head and a stem, wherein the stem moves upon rotation of the rotary head to open the valve means;

iv. nozzle means for spraying the liquid contained in the container when the valve means is opened by the stem;

v. motor means for rotating the rotary head of the valve actuating means and moving the stem for opening and closing the valve means; and

vi. control means connected to the motor means for controlling the operation of the motor means for automatically providing doses of sprayed liquid through the nozzle means.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 diagrammatically shows a cross-sectional elevation view of an automatic device according to a preferred embodiment of the invention;

FIG. 2 shows a partial elevation view of an upper end of an aerosol container with an automatic actuator of the invention mounted thereon;

FIG. 3 shows a partially cross-sectional, elevation view of the components of the device of the invention, with the main support in phantom lines, mounted in an aerosol container and connected to the valve tube of the aerosol container; and

FIG. 4 shows a top plan view of part of the control means;

### DESCRIPTION OF THE PREFERRED EMBODIMENTS

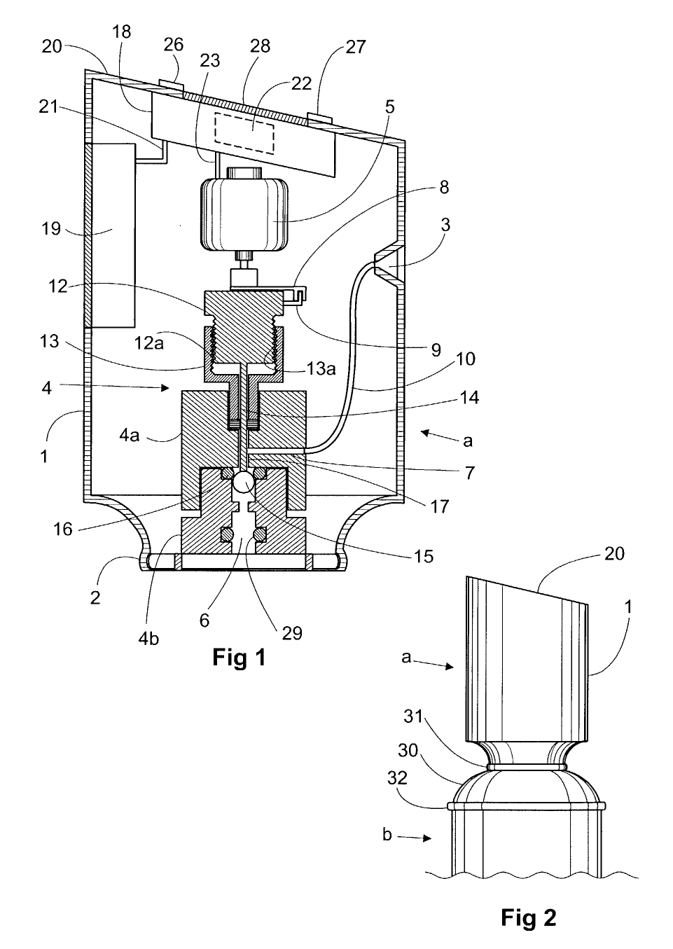

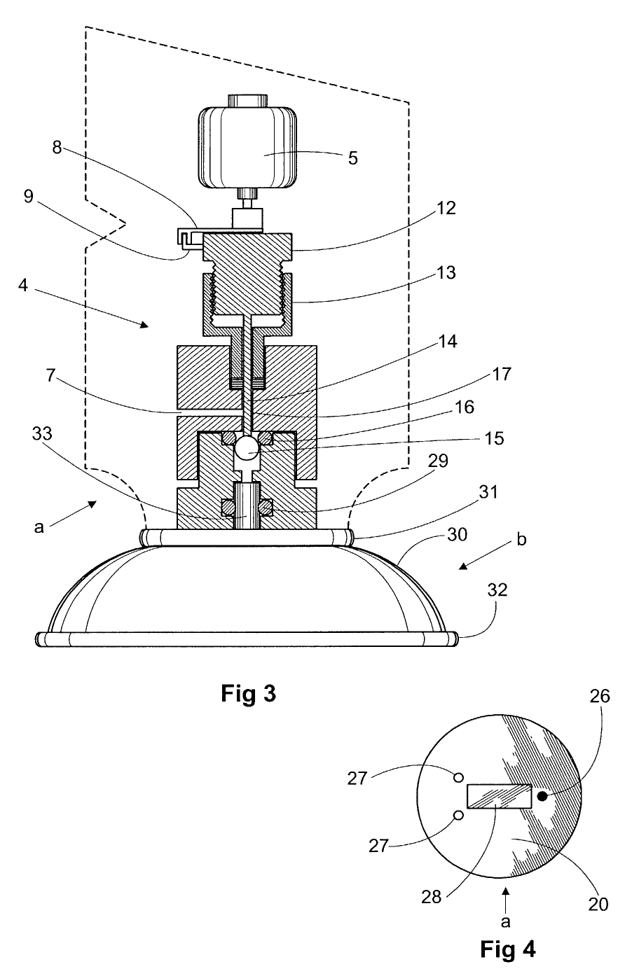

Now referring in detail to the drawings it may be seen from FIGS. 1-3 an automatic device or actuator, generally indicated by reference a, for actuating an aerosol valve of a conventional aerosol container, generally indicated by reference b, wherein the inventive device is capable of providing controlled doses of a liquid contained in container b. The purpose of automatic device a is to be removably mounted onto an upper end 30, FIG. 3, of container b and connected to a valve tube 33 of a conventional aerosol valve for providing periodically controlled spraying of doses of liquid under predetermined conditions. Generally, the aerosol valve comprises the valve tube projecting beyond the upper end of the container and the valve tube is operated to open the aerosol valve by depressing the tube against the action of a spring (not shown). The conditions under which the aerosol valve may be operated by the inventive device may comprise, but not restricted to, periodical spraying at desired lapses of time, spraying into a room when a light is turned on or a room door is opened, etc. For these purposes, the device will be provided with any kind of well known sensors, timers, detectors, etc.

Device a comprises a main support or head hollow cap 1, having a base 2 defining a coupling edge for coupling to at least one rim 31, 32, FIG. 3, of the aerosol container, with base 2 having the desired diameter to be adapted to several rims 31, 32. This permits the inventive device to be mounted onto the aerosol container in a removable manner in such a manner that the device may be re-used in a new container when the first one has been emptied. All the components of the automatic device remains properly housed into cap 1 except those ones, reference to which will be made later, that need to be accessible to the user.

Device a also comprises a normally closed valve means 4 housed in the support for connecting to the valve tube, as shown in FIG. 3, in a manner that the tube remains depressed, that is with the aerosol valve open, while connected to the valve means. The normally closed valve means comprises an upper valve body 4a and a lower valve body 4b which are connected together and firmly retained into the main support. Lower valve body 4b has an entrance 6 for connecting to the valve tube, as shown in FIG. 3, in a manner that the tube remains depressed, therefore, the aerosol valve is open and the liquid of the container enters the entrance 6 For preventing the liquid from flowing out of the device a valve stopper 15 is normally closing a seat defined by an O-ring 16 mounted in a connection between the upper 4a and the lower 4b valve bodies. An additional O-ring 29 provided in entrance 6 seals against valve tube 33.

Upper valve body 4a includes a conduit 7 for conducing the liquid when the valve stopper 15 is moved out of seat 16. Conduit 7 also comprises a vertical conduit portion 17 reference to which will be made below. Conduit 7 of the upper valve body is connected to nozzle means 3 by means of a flexible tube 10. Nozzle means 3 may be of any conventional type for spraying the liquid contained in the container when the valve means is opened.

Valve actuating means for opening and closing valve means 4 is also provided. The valve actuating means comprises a rotary head 12, a guiding support 13 and a stem 14. Rotary head 12 comprises a solid piece provided with an outer thread and guiding support 13 is a cup-like shaped member having a threaded inner surface 13a, wherein rotary head 12 is nested into the guiding support and threadably connected to threaded inner surface 13a of the guiding support, whereas when the rotary head 12 rotates into the guiding support in opposite senses the rotary head moves up and down.

Stem 14 is fixed to a lower portion of rotary head 12 whereas when the head rotates into the guiding support the stem moves up and down. The stem moves into at least part of the conduit of the upper valve body, more precisely into conduit portion 17, for actuating on valve stopper 15 to move the valve stopper out from seat 16 in order to open normally closed valve means 4. Stem 14 will be properly sealed into conduit portion 17 in order to prevent the liquid from escaping through conduit portion 17.

Motor means, preferably an electrical motor 5, is provided to rotate rotary head 12 of the valve actuating means. For moving the head, motor 5 is provided with a motor arm 8, radially extended from the motor, and head 12 is provided with a radially extended arm 9, which arms are connected at the ends thereof for transmitting the movement from the motor to the rotary head.

According to a preferred embodiment, motor 5 may rotate in two opposite senses, a first sense, to move stem down and open the valve means, and in a second opposite sense to move the stem up to close the valve. Alternatively, motor 5 may rotate in only one sense to move the stem down, to open the valve means, and spring means may be provided, connected to arm 8 for example, to move the stem up, back to the original upper position to close the valve means.

To operate according to a desired and programmed pattern, motor 5 is connected by a connection 23 to control means 18, for controlling the operation of the motor for controllably opening and closing the valve means in order to provide periodical doses of sprayed liquid through nozzle 3. Control means 18 preferably comprises a power supply 19 to which is connected through a connection 21, and a temp stage 22. Power supply 19 preferably comprises at least one battery mounted into the main support, the battery feeding the electric motor.

Control means 18 further comprises means for regulating the temp stage, for example push buttons 27 are provided at the top 20 of cap 1, FIG. 4, for regulating the extension of the periods of time, or intervals, between the sprayings. A light sensor 26 and a display screen 28 are also included within the control means. Light sensor is provided to stop the operation of the automatic device during the night, for example. Temp stage 22 actuates to provide the motor with the control of the timing for operation thereof and screen 28 may provide the user with any necessary information about the spraying pattern that has been selected.

While preferred embodiments of the present invention have been illustrated and described, it will be obvious to those skilled in the art that various changes and modifications may be made therein without departing from the scope of the invention as defined in the appended claims.

We claim:

1. Automatic actuator for aerosol valves of conventional aerosol containers for spraying a liquid contained in the containers, wherein the aerosol valve comprises a valve tube projecting beyond the container and the valve tube is operated to open the aerosol valve by depressing the tube against the action of a spring, the automatic actuator comprising:
i. a main support for mounting onto the aerosol container;
ii. normally closed valve means in the support for connecting to the valve tube in a manner that the tube remains depressed while connected to the valve means;
iii. valve actuating means for opening and closing the valve means, the valve actuating means comprising a rotary head and a stem, wherein the stem moves upon rotation of the rotary head to open the valve means;
iv. nozzle means for spraying the liquid contained in the container when the valve means is opened by the stem;
v. motor means for rotating the rotary head of the valve actuating means and moving the stem for opening and closing the valve means; and
vi. control means connected to the motor means for controlling the operation of the motor means for automatically providing doses of sprayed liquid through the nozzle means.

2. The actuator of claim 1, wherein the main support comprises a hollow cap with a base having a coupling edge for coupling to at least one rim provided in the aerosol container.

3. The actuator of claim 1, wherein the normally closed valve means comprises an upper valve body and a lower valve body connected together and to the main support, the lower valve body having an entrance connectable to the valve tube, in a manner that the tube remains depressed, and a valve stopper normally closing a seat defined in a connection between the upper and the lower valve bodies, the upper valve body including a conduit for conducing the liquid when the valve stopper is moved out of the seat.

4. The actuator of claim 3, wherein the conduit of the upper valve body is connected to the nozzle means by means of a flexible tube.

5. The actuator of claim 1, wherein the control means comprises a power supply and a temp stage.

6. The actuator of claim 3, wherein the valve actuating means further comprises a guiding support having a threaded inner surface and the rotary head is nested into the guiding support, the rotary head including an outer thread which is threadably connected to the threaded inner surface of the guiding support, whereas when the rotary head rotates into the guiding support the rotary head moves up and down.

7. The actuator of claim 6, wherein the stem is fixed to the rotary head whereas when the head rotates into the guiding support the stem moves up and down into at least part of the conduit of the upper valve body for actuating on the valve stopper and move the valve stopper out from the seat and open the normally closed valve means.

8. The actuator of claim 7, wherein the rotary head of the valve means comprises a radially extended arm connected to a motor arm radially extended from the motor means, the arms being connected to transmit the movement from the motor means to the rotary head.

9. The actuator of claim 5, wherein the power supply comprises at least one battery mounted into the main support.

10. The actuator of claim 9, wherein the motor means is an electric motor fed by the at least one battery.

11. The actuator of claim 5, wherein the control means further comprises means for regulating the temp stage.

12. The actuator of claim 5, wherein the control means further comprises a light sensor.

13. The actuator of claim 5, wherein the control means further comprises a display screen.

14. The actuator of claim 8, wherein the motor arm is provided with spring means for moving the arm back to a position wherein the valve means is closed.
